(19) United States
(12) Patent Application Publication
(10) Pub. No.: US 2022/0343383 A1
(43) Pub. Date: Oct. 27, 2022

(54) Cannabis System for Growing, Creating and Purchasing Cannabis Products

(71) Applicant: Brian Garcia Rivera, New York, NY (US)

(72) Inventor: Brian Garcia Rivera, New York, NY (US)

(21) Appl. No.: 17/725,244

(22) Filed: Apr. 20, 2022

Related U.S. Application Data
(60) Provisional application No. 63/178,239, filed on Apr. 22, 2021.

(51) Int. Cl. G06Q 30/06

(52) U.S. Cl. CPC G06Q 30/0607; G06Q 30/0637

(57) ABSTRACT

The present invention relates to a system and method using a computer implemented application or a website for facilitating the creation and ordering of cannabis related products. The system can be used by customers for customizing their cannabis or marijuana farming choices via selection of seeds, strains, THC levels, and more. The system enables sellers to receive customized orders from the customers and the orders are processed and dispatched through delivery partners or clients. In one example, a customer selects functions and performs a purchase to enable the customer to purchase cannabis products. The client or seller receives the customer order and dispatches the order. A plurality of back-end users manage the system by monitoring sales, purchases, onboarding of customers and clients, and more.

### CROSS-REFERENCE TO RELATED APPLICATION

The present application claims priority to, and the benefit of, U.S. Provisional Application No. 63/178,239, which was filed on Apr. 22, 2021 and is incorporated herein by reference in its entirety.

### FIELD OF THE INVENTION

The present invention relates generally to the field of delivery systems. More specifically, the present invention relates to a cannabis delivery system that is a software application to facilitate creation and order of cannabis/marijuana-related products. The cannabis delivery system enables the users to customize their marijuana farming choices via selections from the group consisting of seeds, strain, THC level, and more, and receive their order delivered at the desired address without any inconvenience. The invention also includes a game to allow the individuals to virtually grow legal amounts of plants per delivery cycle (i.e. legal amount deliverable in one day) and offers a fun way to purchase the fully grown plants once the game ends. Other products, not limited to plants and farming, can be part of the game to enable users to virtually maintain the plants, property, and equipment. The invention obviates the need to physically visit a local dispensary to buy cannabis and other similar items. Accordingly, the present disclosure makes specific reference thereto. Nonetheless, it is to be appreciated that aspects of the present invention are also equally applicable to other like applications, devices, and methods of manufacture.

### BACKGROUND

By way of background, cannabis (also known as marijuana) is a psychoactive drug from the cannabis plant. Individuals can use the dried leaves, seed oil, and other parts of the cannabis plant for recreational and medicinal purposes. The cannabis plant can have a pleasurable effect and may soothe the symptoms of various conditions, such as chronic pain. Additionally, studies have shown that cannabis can help to manage nausea resulting from chemotherapy treatment, some symptoms of multiple sclerosis (MS), depression, anxiety and more. Individuals may use cannabis in various forms such as smokables, edibles, topicals, oils, capsules, gummy candies, etc., and the onset of its effects is felt within minutes of cannabis intake.

Generally, to purchase marijuana, individuals visit a local dispensary and at times they may be forced to wait in lines outside small shops to get the desired amount of marijuana. With the increasing demand for marijuana, being forced to wait long hours to make a single purchase can lead individuals to feeling uncomfortable. Further, after leaving a dispensary, individuals must navigate their way, for example, to their vehicle in a safe and protected manner. Also, even after waiting for long hours in a queue outside a local dispensary, cannabis stock may be depleted before the individual has an opportunity to purchase the cannabis. This may cause disappointment among customers.

The customers usually get bored in the process of physically buying cannabis from local dispensaries and may be reluctant in getting into queues for purchasing the desired cannabis product. Also, physical presence is required for purchasing cannabis, and for this, individuals are required to take out time from their busy schedules. Current cannabis purchasing methods leads to wasting time and effort. Additionally, delivery times can be prohibitive and inefficient.

Therefore, there exists a long-felt need in the art for a cannabis purchasing solution that enables the individuals to buy cannabis related products without visiting local dispensaries. There is also a long-felt need in the art for a cannabis purchasing method that obviates the need to line up in queues outside the local dispensaries to buy cannabis. Additionally, there is a long-felt need in the art for a cannabis purchasing solution that saves the time of the user by obviating them from lining up for long hours outside a dispensary to get cannabis. Moreover, there is a long-felt need in the art for a cannabis purchasing solution that ensures all the individuals are able to buy cannabis related products easily, without any hassles of taking out time from their busy schedules to physically visiting local dispensaries. Further, there is a long-felt need in the art for a cannabis purchasing solution that provides a fun way of purchasing cannabis from stores. Finally, there is a long-felt need in the art for a cannabis purchasing solution that prevents wasting time and effort caused by standard methods of purchasing cannabis related products.

The subject matter disclosed and claimed herein, in one embodiment thereof, comprises a cannabis game system including a cannabis application and/or a cannabis web portal. Moreover, the cannabis application and/or a cannabis web portal can be accessed by a customer, a client/seller, and a back-end user. The customer, a client/seller, and a back-end user can be required to register themselves before being able to access the cannabis management system. The registration process requires credentials and after authentication of the credentials using a single sign-on method, access of the system is enabled. Some states use a 2-step authentication mandate in order to ensure compliance of the customer with legal constraints. Upon entry into the system, the customer is enabled to play a cannabis game. The cannabis game enables customers to create and potentially order marijuana products. The customer can choose the farming options selected from the dirt, seeds, strain, THC level, etc. within the game. Individuals can then grow the legal amount per delivery cycle in real-time. The app also offers cartoons and fun graphics, along with real-time videos of the plant growing before it is delivered. Once the game is finished, users may connect with a dispensary of their choice to obtain a legal purchase of the plant.

In this manner, the system and associated method of the present invention accomplishes all of the forgoing objectives and provides a system that enables the individuals to customize their cannabis products in a fun way and buy cannabis related products without visiting local dispensaries. The system enables customers to purchase cannabis products in a legal way compliant with state regulations. The system enables customers to play a game, customize products and enables sellers to receive business by receiving orders and dispatching physical cannabis products to customers.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for providing a game for virtually growing a legal amount of cannabis product for ordering from a laboratory for physical delivery of corresponding cannabis product. The method comprising the steps of registering a customer, receiving preferences of cannabis products from the customer, receiving a cannabis product order from the customer, sending the order to a client or seller, receiving confirmation of processing, dispatching of the order from the seller, and managing sale and purchase of the cannabis product on the game system between the seller and the customer.

In yet another embodiment, the method includes displaying a customized dashboard to the customer providing game interaction options.

In yet another embodiment, the method further includes displaying in-game purchases icon allowing the customer to purchase cannabis products wherein the purchase order is sent to a client located in the same state of the customer.

In yet another embodiment, the method further includes changing the character, player or avatar of the customer.

In yet another embodiment, a cannabis game system is disclosed. The cannabis game system includes a cannabis application and/or a cannabis web portal. Moreover, the cannabis application and/or a cannabis web portal can be accessed by a customer, a client/seller, and a back-end user. The customer, a client/seller, and a back-end user are required to register themselves before being able to access the cannabis management system. The registration process requires credentials, and after authentication of the credentials using a single sign-on method, access of the system is enabled. Upon entry into the cannabis system, the customer is enabled to play a cannabis game. The cannabis game enables customers to create and potentially order marijuana products. The customer can choose the farming options selected from the dirt, seeds, strain, THC level, etc. within the game. Individuals can then grow the legal amount per delivery cycle in real-time. The app also offers cartoons and fun graphics, along with real-time or time-lapsed videos of the plant growing before it is delivered. Once the game is finished, users may connect with a dispensary of their choice to obtain a legal purchase of the plant.

In yet another embodiment, the system, including a server system, comprising an application or web server for rendering user interfaces and a database for storing credentials of users of the system.

In a further embodiment of the present invention, the customer is of a legal age and is compliant with the state and other regulations to play the game, i.e., select the functions.

In a further embodiment of the present invention, the customer can make in-game upgrades, build various buildings, construct labs, and/or purchase land.

In a further embodiment of the present invention, the customer can purchase upgrades which in-turn will result in deliveries of the physical product.

The advantage of the cannabis management system of the present invention is that it provides users with a software application or website designed to facilitate the creation and ordering of cannabis-related products. Further, the cannabis management system enables users to connect with a dispensary to customize their marijuana farming choices via dirt, seeds, strain, THC level, and more. Further, the cannabis management system enables individuals to virtually grow the legal amount of the plant per delivery cycle and/or purchasable from a dispensary. Further, the cannabis management system offers a way to have fun growing the cannabis plant all while having the option to purchase the completed plant after the game ends.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to enabled drawings in which similar reference characters refer to similar parts throughout the different views, and in which:

FIG. 1 illustrates a schematic view of one potential embodiment of a cannabis management system 100 of the present invention in accordance with the disclosed architecture;

FIG. 2 illustrates a block diagram view showing components of the application/web server 110 of the cannabis management system 100 for performing various functions in accordance with the disclosed architecture;

FIG. 3A illustrates a flow diagram depicting a process of customer authentication for providing access of functionalities enabled by the system 100 of the present invention in accordance with the disclosed architecture;

FIG. 3B illustrates a flow diagram depicting a process of receiving customer information from a new customer for establishing a customer account to access the game system 100 in accordance with the disclosed architecture;

FIG. 3C illustrates a block diagram depicting various game features enabled to the customer on the customer dashboard for interacting with the game system in accordance with the disclosed architecture;

FIG. 4 illustrates a block diagram view showing the process of use of purchase upgrades by a customer for buying cannabis products in the game system in accordance with the disclosed architecture;

FIG. 5 illustrates an exemplary customer dashboard 500 providing customized game interface and controls for the user to interact with the game in accordance with the disclosed architecture;

FIG. 6A illustrates a flow diagram depicting a process of a client (lab) authentication for receiving orders into dashboard from customers of the game system 100 in accordance with the disclosed architecture;

FIG. 6B illustrates a flow diagram depicting a process of a receiving client information from a new client for establishing a client account to onboard the game system 100 in accordance with the disclosed architecture;

FIG. 7 illustrates an exemplary client interface displayed to a client for managing orders and inventory in accordance with the disclosed architecture;

FIG. 8 illustrates a flow diagram depicting a process of processing customer orders by a client on the system 100 in accordance with the disclosed architecture;

FIG. 9 illustrates a flow diagram depicting a process of authenticating a back-end user of the system of the present invention in accordance with the disclosed architecture;

FIG. 10 illustrates an exemplary back-end user interface displayed to a back-end user in accordance with the disclosed architecture;

FIG. 11 illustrates a flow diagram showing the process of enrolling back-end user and storing information in accordance with the disclosed architecture;

FIG. 12 illustrates a flow diagram showing steps of providing access of the game system to a back-end user in accordance with the disclosed architecture; and

FIG. 13 illustrates a flow diagram showing various tasks performed by a customer for customizing the cannabis products while playing the game in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a cannabis purchasing solution that enables the individuals to buy cannabis related products without visiting local dispensaries. There is also a long-felt need in the art for a cannabis purchasing method that obviates the need to line up in queues outside the local dispensaries to buy cannabis. Some states use a 2-step authentication mandate in order to ensure compliance of the customer with legal constraints. Additionally, there is a long-felt need in the art for a cannabis purchasing solution that saves the time of the user by obviating them from lining up for long hours outside a dispensary to get cannabis. Moreover, there is a long-felt need in the art for a cannabis purchasing solution that ensures all the individuals are able to buy cannabis related products easily, without any hassles of taking out time from their busy schedules and physically visiting local dispensaries. Further, there is a long-felt need in the art for a cannabis purchasing solution that provides a fun way of purchasing cannabis from stores. Finally, there is a long-felt need in the art for a cannabis purchasing solution that prevents wasting time and effort caused by standard methods of purchasing cannabis related products.

The present invention, in one exemplary embodiment, is a novel method for providing a game for virtually growing a legal amount of cannabis product for ordering from a laboratory for physical delivery of corresponding cannabis product. The method comprising the steps of registering a customer, receiving preferences of cannabis products from the customer, receiving a cannabis product order from the customer, sending the order to a client or seller, receiving confirmation of processing, dispatching the order from the seller, and managing sale and purchase of the cannabis product on the game system between the seller and the customer.

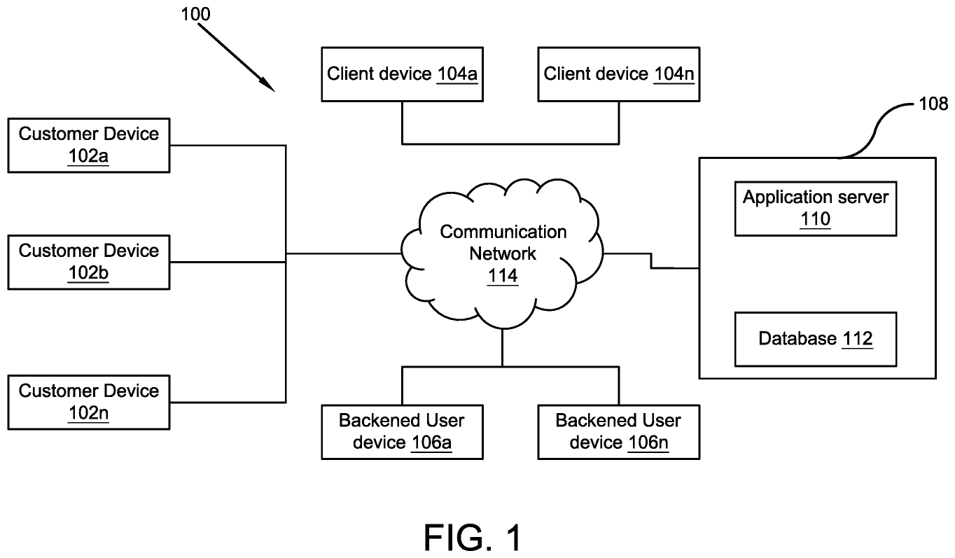

Referring initially to the drawings, FIG. 1 illustrates a schematic view of one potential embodiment of a cannabis management system 100 of the present invention in accordance with the disclosed architecture. The cannabis management system 100 is designed to provide customers with a software application or website designed to facilitate the creation and order of cannabis-related products. The ordered items are sold by clients or sellers (laboratories) onboarded on the system 100. The processing or functionality, and especially interaction, between customers and sellers are managed and monitored by a plurality of back-end users wherein the back-end users have a variety of roles for managing functionality of the system. As illustrated, the system 100 is designed to have a plurality of customers who play the game, i.e., select the functions, offered by the system using customer devices 102a-n. The customers play the game, i.e., select the functions, and perform in-game purchases to farm and buy cannabis products. The customer devices 102a-n can be any computing device such as a handheld electronic device or a fixed computer system. The customers can access the system 100 using either a computer implemented software application or a website accessible on a browser.

A plurality of clients, sellers, or laboratories are providers of cannabis products and receive orders from customers of the system 100. It is to be appreciated that the clients are compliant with state regulations and are able (i.e., licensed) to sell regulated cannabis products. The clients use client devices 104a-n, wherein the client devices 104a-n can be any computing device such as a handheld electronic device or a fixed computer system. The clients can access the system 100 using either a computer implemented software application or a website accessible on a browser.

A plurality of back-end users are responsible for onboarding customers and clients and monitoring reports, sales, settings, and more. The back-end users have a plurality of roles that enables the management of the system 100 and interaction between the clients and the customers. The back-end users use user devices 106a-n that can be any computing device such as a handheld electronic device or a fixed computer system. The users can access the system 100 using either a computer implemented software application or a website accessible on a browser.

The customer devices 102a-n, the client devices 104a-n, and the back-end devices 106a-n are configured to access a server system 108 that includes an application/web server 110 coupled to a database 112 using a communication network 114.

Further, the database 112 may be configured for storage and retrieval of data associated with the cannabis management system 100. According to embodiments of the present invention, the database 112 may be, but is not limited to, a centralized database, a distributed database, a personal database, an end-user database, a commercial database, a Structured Query Language (SQL) database, a Non-SQL database, an operational database, a relational database, a cloud database, an object-oriented database, a graph database, and so forth. The database 112 is configured to store customer information, client information and back-end information along with inventory information of the clients and order information of the customers as described later in the disclosure.

Furthermore, the application server 110 may be a centralized, distributed or cloud server for housing components associated with the cannabis management system 100 for the purpose of receiving, storing, processing, and distributing data. The application server 110 may enable the customer to play a cannabis game on the customer device 102.

The communication network 114 may include suitable logic, circuitry, and interfaces that may be configured to provide a plurality of network ports and a plurality of communication channels for transmission and reception of data related to operations of various entities (such as the user device in which the application is installed, or website is accessed and the server system 108). The communication network 114 may be associated with an application layer for implementation of communication protocols based on one or more communication requests from the application/website and the server system 108. The communication data may be transmitted or received via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

In one embodiment, the communication data may be transmitted or received via at least one communication channel of a plurality of communication channels in the communication network 114. The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

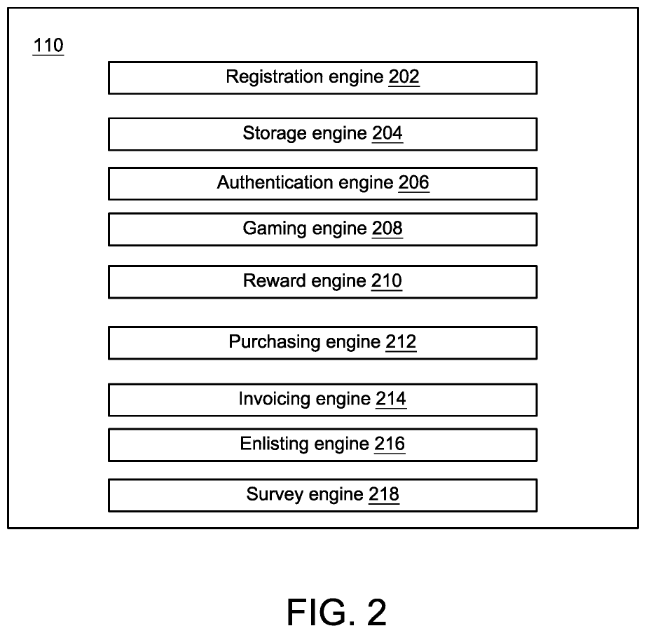

FIG. 2 illustrates a block diagram view showing components of the application/web server 110 of the cannabis management system 100 for performing various functions in accordance with the disclosed architecture. More specifically, the server 110 includes a registration engine or module 202, a storage engine or module 204, an authentication engine or module 206, a gaming engine or module 208, a reward engine or module 210, a purchasing engine or module 212, an invoicing engine or module 214, an enlisting engine or module 216, and a survey engine or module 218.

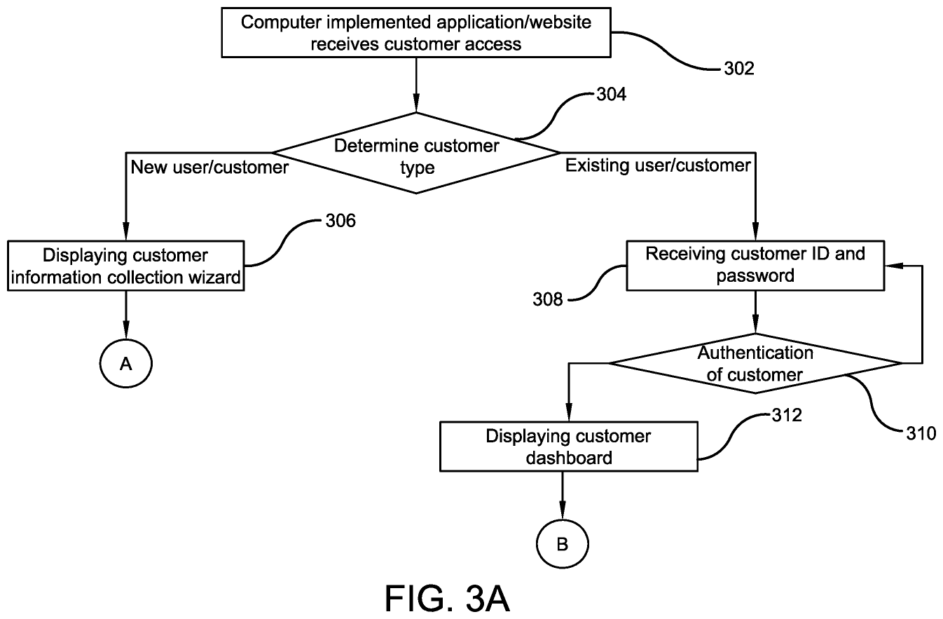

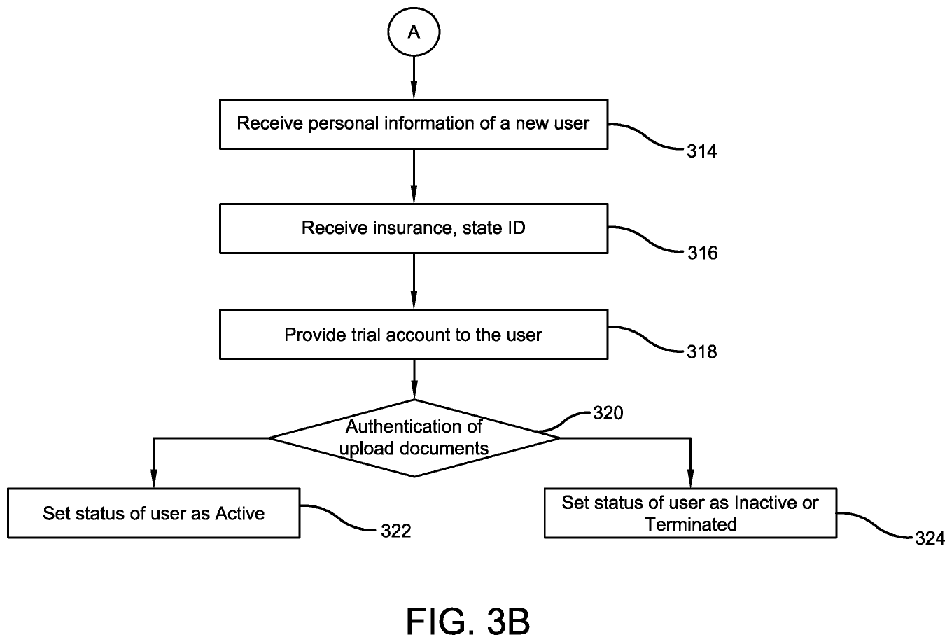

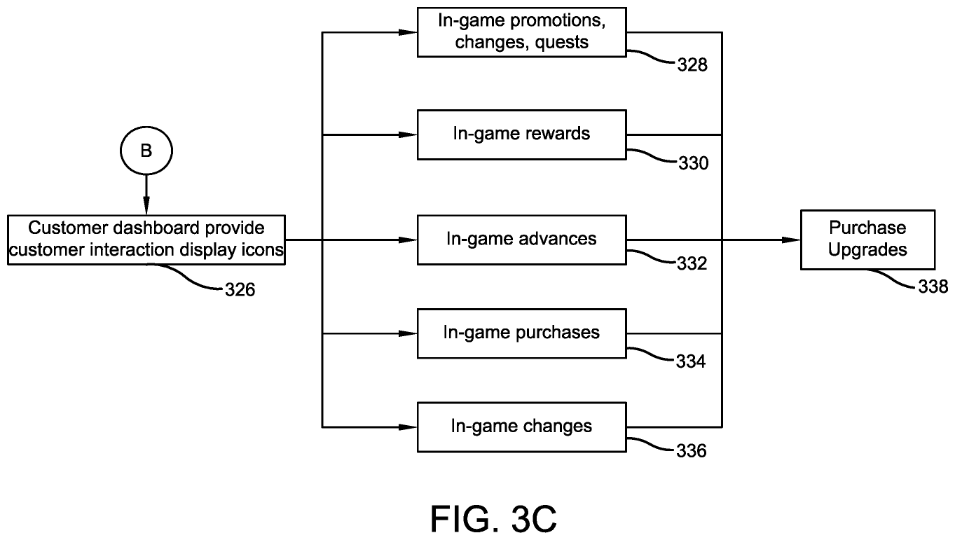

The registration engine or module 202 is configured to enable customers, clients, and back-end users to register on the cannabis management system 100 through a cannabis software application and/or a cannabis web portal. In an exemplary scenario, if the user is a customer, then the customer registers himself into the cannabis management system 100 by entering personal information such as, but not limited to, a name, an email ID, a date of birth (DOB), an address, and so forth. The customer can further upload images of an identification card, a driving license, a license, and so forth. Apart from this, the customer has to create a unique customer ID and a password that will be used for future logins. Details of customer registration are described in FIGS. 3A and 3B.

In another exemplary scenario, if the user is a client/seller, then the client/seller registers himself into the cannabis management system 100, by entering a shop name, an email, an address, a contract/agreement, an inventory, and so forth. Apart from this, the client/seller has to create a unique client ID and a password that will be used for future logins. In yet another exemplary scenario, if the user is a back-end user selected from one of, an admin, a sales officer, and a manager, the back-end user registers into the cannabis management system 100 using an enrollment/candidate number.

The storage engine or module 204 is configured to enable storage of the personal information, client information, and other information received during the registration of the new customer, client, and back-end user. The storage engine or module 204 may be connected to the database 112 that may be used to store all the received information.

The authentication engine or module 206 is configured to authenticate the user by receiving the unique customer ID, client ID, back-end ID, and password. According to an embodiment of the present invention, the authentication module 206 compares the received unique customer ID, client ID, back-end ID, and password from the customer devices 102a-n, the client devices 104a-n, and the back-end user device 106a-n, respectively, with the unique customer ID, client ID, back-end ID, and password stored in the database 110 for performing authentication. Further, the authentication engine or module 206 uses a Single Sign-On (SSO) method to authenticate the users according to another embodiment of the present invention.

The gaming engine or module 208 may be configured to enable the customers to play the cannabis game using a cannabis application and/or a cannabis web portal. The gaming engine or module 208 provides a dashboard that enables the customers to play the game, i.e., select the functions, while allowing the customers to create and potentially order marijuana products. The gaming engine or module 208 further enables the customer to choose the farming options selected from the dirt, seeds, strain, THC level, etc., within the game for the ordered product. The customer can then grow the legal amount per delivery cycle in real-time. The gaming engine or module 208 also offers cartoons and fun graphics, along with a real-time or time-lapsed video of the plant growing before it is delivered to the customers.

The reward engine or module 210 is configured to enable the user to earn rewards while playing the game on the customer device 102. The reward can be shared based on the progress, completion of stages, general playtime, money spent, contests played, and so forth. The reward engine or module 210 further enables the customer to encash the earned rewards for purchasing the cannabis product.

The purchasing engine or module 212 is configured to manage the processing of orders, exchange, product line, upgrades, and deliveries of requested goods, and so forth. The purchasing engine or module 212 enables the customer to manage purchases. Similarly, the purchasing engine or module 212 also enables the client to manage purchases, order cannabis, and other similar products.

The invoicing engine or module 214 may be configured to enable the back-end user to generate invoices for the product ordered. The invoicing engine or module 214 also enables the customers and the clients/sellers to receive invoices of the various purchases made using the cannabis application and/or cannabis web portal.

The enlisting engine or module 216 may be configured to enable the client/seller to enlist cannabis products. The enlisting engine or module 216 may also be configured to enable the client/seller to manage the enlisted products.

The survey engine or module 218 may be configured to generate a questionnaire for the customers. The questionnaire may comprise various questions related to the quality of the service offered, products of interest, and other service-related questions.

FIG. 3A illustrates a flow diagram depicting a process of a customer authentication for providing access of functionalities enabled by the system 100 of the present invention in accordance with the disclosed architecture. A customer is a user that plays or selects the virtual cannabis plant growing function enabled by the system 100. The customer is of legal age (legal age for ordering and consuming cannabis products) and is also compliant with the state and other regulatory rules for selecting the cannabis plant growing function. As illustrated, initially, a customer accesses the software application or the website for accessing functionalities and features enabled by the system (Step 302). Thereafter, the type of the customer is determined by the system (Step 304). In situations where the customer is determined to be a new user/customer, then a customer information collection wizard is displayed to the customer enabling the customer to input all relevant information (Step 306). The process of receiving personal and other relevant information is illustrated in FIG. 3B.

In situations where the customer is determined to be an existing customer of the system in Step 304, then customer credentials including customer ID and password are received from the customer (Step 308). Thereafter, authentication of the credentials take place in step 310. If the credentials are successfully authenticated in step 310, then a customized dashboard of game of the customer is displayed in step 312 allowing the customer to play the game, i.e., select the functions, as described in FIG. 3C or else the customer is asked to re-enter the credentials for successful authentication.

FIG. 3B illustrates a flow diagram depicting a process of a receiving customer information from a new customer for establishing a customer account to access the game system 100 in accordance with the disclosed architecture. When the customer is identified as a new customer and the customer information collection wizard is displayed to the customer, then, personal information including first name, last name, e-mail, date of birth, home address, and other relevant information is obtained from the customer (Step 314). Thereafter, additional documents like insurance and state ID are received from the customer (Step 316).

Upon successfully receiving the information in steps 314 and 316, a trial account with limited features is enabled to the customer that remains active until the documents received from the customer are authenticated successfully (Step 318). The system performs authentication of the uploaded documents and information in step 320 and if the information is successfully authenticated, the status/profile of the user is set as Active in step 322 and all features of the game system become accessible to the customer. If the information cannot be authenticated, the status of the user account is set as Inactive or Terminated in step 324 and the game system becomes inaccessible to the customer.

FIG. 3C illustrates a block diagram depicting various game features enabled to the customer on the customer dashboard for interacting with the game system in accordance with the disclosed architecture. As described in FIG. 3A, when a customer is successfully authenticated, a customized 2D dashboard is displayed to the customer. The dashboard is configured to provide a plurality of customer interaction display icons (Block 326). In-game promotions, changes, quests icon 328 provides dynamic changes in the game interface, avatar character of the customer and more. The changes are based on templates, keywords, and schedules. A customer is enabled game quests and quest rewards when the customer clicks on the icon 328. The dynamic quest is created in the game with the selected one or more templates or scheduled tasks and the selected one or more templates or scheduled rewards.

In-game rewards icon 330 provides rewards to a user based on progress, completion of game stages, and on general playtime. The rewards may be enabled to the customer implicitly while playing the game or explicitly when the in-game rewards icon 330 is clicked by the customer. The customer may acquire game points, gold coins, experience points, character levels, character attributes, virtual cash, or other in-game items of value.

In-game advances icon 332 enables a customer to see the potential in-game advances for which the customer is eligible. The customer receives in-game advances that include various product updates, level-ups, land purchases for growing and farming cannabis, lab purchases for cannabis processing and more.

In-game purchases icon 334 enables the user to purchase lands, labs, more gametime for physical delivery of cannabis products by using cryptocurrency. In-game changes icon 336 enables the game to dynamically adapt and enables the customer to grow or adapt with the game.

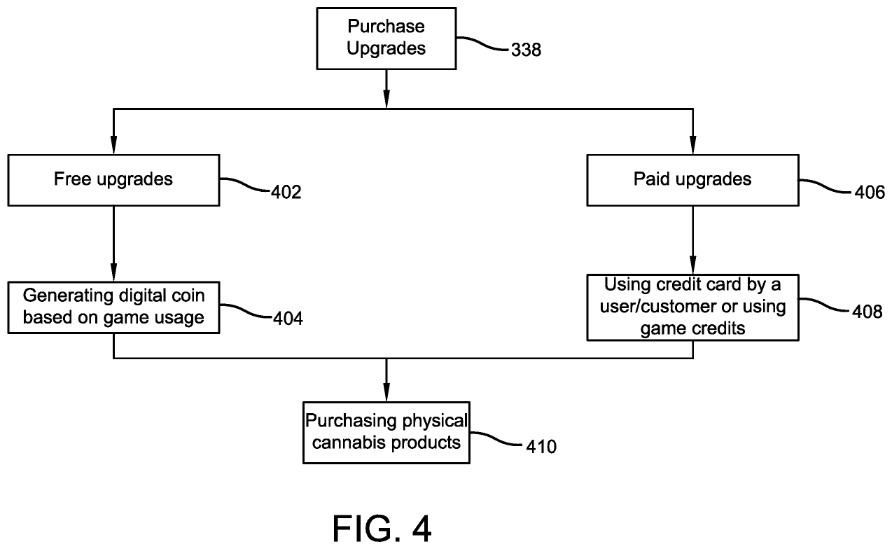

Purchase upgrades 338 enables the customer to upgrade all the advances, rewards, purchases, and others offered by the game system to the customer, thereby allowing the customer to interface with a delivery partner to order and receive a cannabis product order. Details of the purchase upgrades 338 is described in FIG. 4.

FIG. 4 illustrates a block diagram view showing the process of use of purchase upgrades by a customer for buying cannabis products in the game system in accordance with the disclosed architecture. The in-game purchases, rewards, advances, changes and more can be upgraded by a customer for purchasing physical cannabis that can be processed by one or more of the clients registered on the gaming system and delivered to the customer by one or more delivery partners. As illustrated, the upgrades can be done by free upgrades (Block 402) enabled to the customer by the game system such as by playing the game and more. A customer gets a digital coin in the game system that can be used by the customer for upgrading the purchase (Block 404).

The customer can use paid upgrades (Block 406) for upgrading the purchases made by the customer. A customer can use a credit/debit card or alternatively can use game credits for upgrading the purchase (Block 408).

In both, free upgrades and paid upgrades, the user may purchase physical cannabis products and interface with one or more delivery partners for contacting with one or more cannabis providers listed on the game system and are in state of the customer.

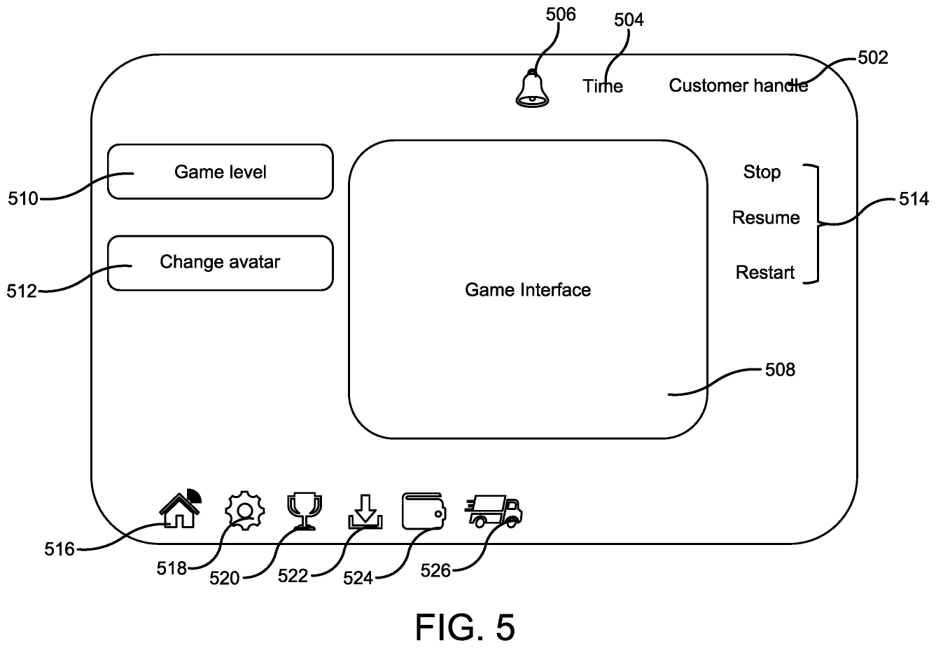

FIG. 5 illustrates an exemplary customer dashboard 500 providing customized game interface and controls for the user to interact with the game in accordance with the disclosed architecture. As illustrated, the customer dashboard 500 is a 2D graphic and displays a customer handle 502. Current time icon 504, displaying the clock time, is also displayed on the top of the dashboard 500 and a notification bar 506, indicating notifications of the customer, is displayed beside the current time icon 504.

A 2D game interface 508 is displayed that has the customer player or character. The color, theme, and other attributes of the game interface 508 may be modified by the customer. A plurality of controls is enabled to the customer for customizing and updating the game. A game level 510 increases or decreases level of the game as per desire and preference of the customer. A change avatar control 512 is used for changing the customer avatar playing the game. A plurality of controls 514 are enabled for stopping, resuming, or restarting the game as per preferences of the customer.

The customer dashboard 500 provides a home icon 516 that enables the user to reach the personalized home page showcasing the pending orders, profile data, and other relevant information. An upgrade/changes icon 518 enables the customer to upgrade the purchases and use both the free upgrades and paid upgrades as described in FIG. 4. A rewards icon 520 enables the customer to view the potential rewards available for the customer. A list of rewards available for the user are listed and one or more rewards can be selected by the customer. A direct purchase option 522 is enabled for enabling the user to purchase cannabis directly by using game purchase. An in-game purchases icon 524 enables the customer to use cryptocurrency for purchasing levels, land, labs, and others in the game. Status of the delivery of the ordered cannabis products can be tracked using the local delivery icon 526. The local delivery icon 526 may also be used for contacting with one or more delivery partners registered on the game platform.

The customer can also purchase a weed book, such as Brave New Weed book, through the dashboard and the book can be supplied by a client/seller enrolled on the platform.

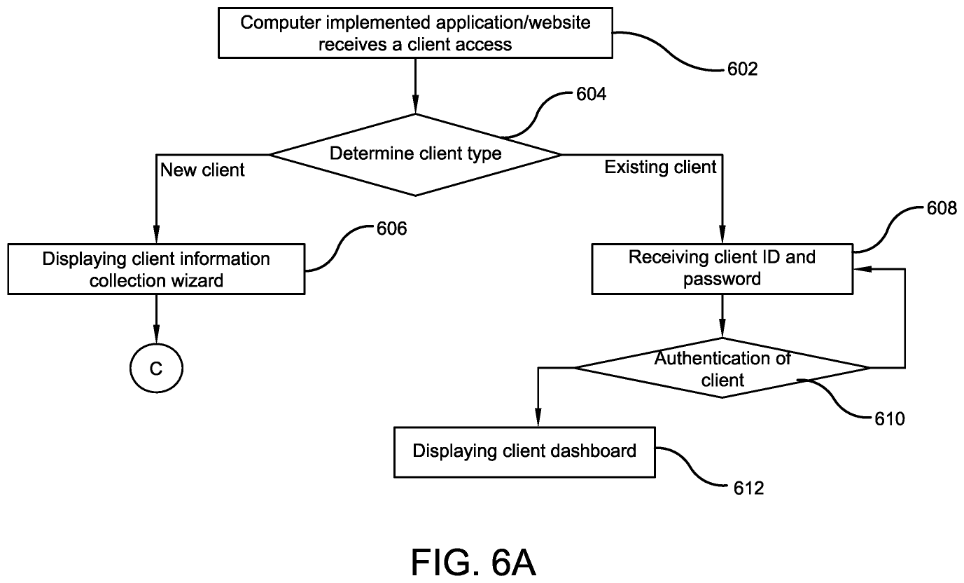

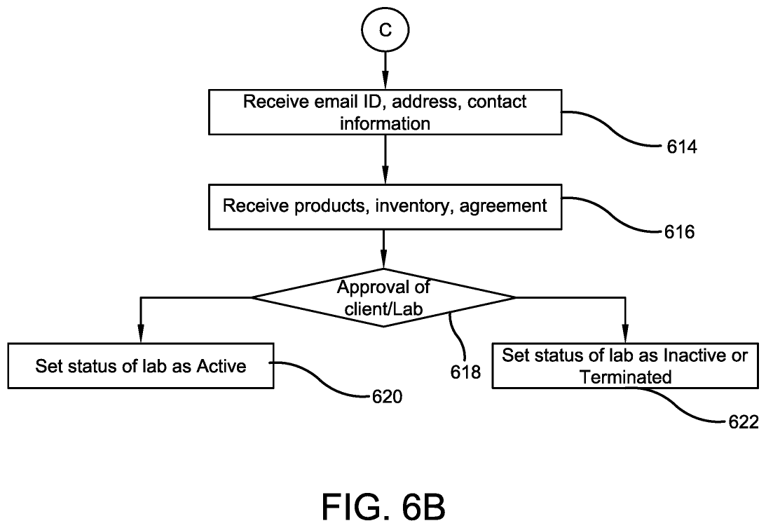

FIG. 6A illustrates a flow diagram depicting a process of a client (lab) authentication for receiving orders into dashboard from customers of the game system 100 in accordance with the disclosed architecture. A client is a seller of a product such as weed, CBD products, rollable and more. The products sold by the client are compliant with state legalization, including allowable amounts. More specifically, the client receives orders into the dashboard based on the customers playing the game and performing in-game purchases. The client then processes and delivers the product to the customer in a physical delivery using one or more delivery partners.

As illustrated, initially, a client accesses the software application or the website for accessing functionalities and features enabled by the system for the clients or labs (Step 602). Thereafter, the type of the client is determined by the system (Step 604). In cases where the client is determined to be a new client/lab, then, a client information collection wizard is displayed to the client enabling the client to input all relevant information for onboarding of the client in the system (Step 606). The process of receiving relevant information is illustrated in FIG. 6B.

In cases where the client is determined to be an existing client of the system in Step 604, then client credentials including client ID, password, and any other relevant information are received from the client (Step 608). Thereafter, authentication of the credentials take place in step 610. If the credentials are successfully authenticated in step 610, then a customized and personalized dashboard of the client is displayed in step 612 allowing the client to access customer orders and inventory management else the client is asked to re-enter the credentials for successful authentication.

FIG. 6B illustrates a flow diagram depicting a process of a receiving client information from a new client for establishing a client account to onboard the game system 100 in accordance with the disclosed architecture. When the client is identified as a new client and the client information collection wizard is displayed to the client, then, e-mail ID, address, contact information and other relevant information are obtained from the client (Step 614). Thereafter, details of products available with the client and corresponding inventory are received from the client (Step 316). As stated earlier, the products sold by the clients are compliant with state legal system.

Upon successfully receiving the information in steps 614 and 616, the system performs authentication of the uploaded information in step 618 and if the information is successfully authenticated, the status/profile of the client is set as Active in step 620 and all features of the game system become accessible to the client. The client, then, can receive orders from customers playing the game and dispatch the orders to the customers. If the information cannot be authenticated, the status of the client account is set as Inactive or Terminated in step 622.

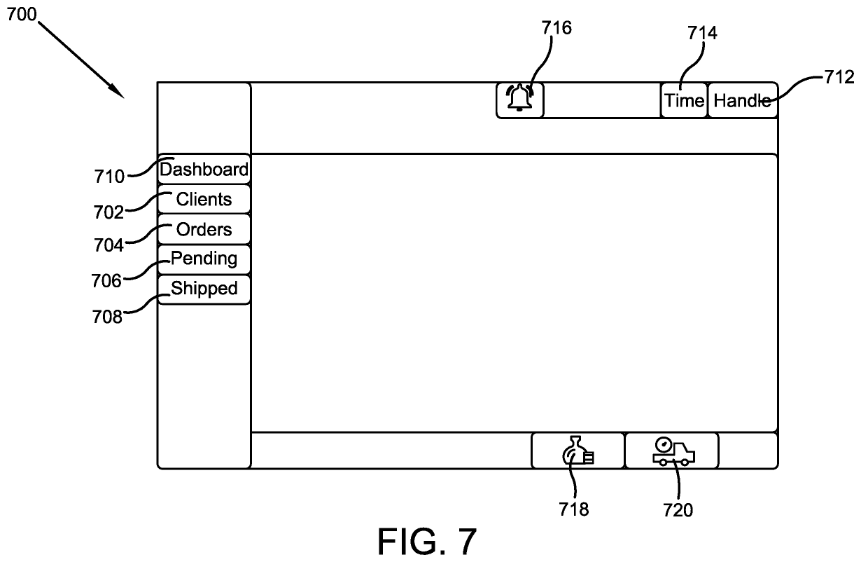

FIG. 7 illustrates an exemplary client interface displayed to a client for managing orders and inventory in accordance with the disclosed architecture. The client/seller dashboard 700 can be accessed using a client device by a client via software application or a website enabled by the system. The dashboard 700 has a clients icon 702, an orders icon 704, a pending orders icon 706, a shipped orders icon 708. The clients button 702 when clicked, displays a list of all the customers who have purchased any sort of cannabis products from the client/seller. As stated earlier, orders of the customers are received by the client when the customers perform in-game purchases. The orders icon 704, when clicked, displays the list of orders placed by the customers along with the status of the order. Orders of individual customers can be individually visible to the client. The pending orders icon 706 when clicked displays the pending orders of the client. A list of pending orders i.e., yet to be shipped are displayed to the client. The shipped button 708, when clicked, displays the tracking details of all the orders. The details may include information such as order name, order value, delivery partner and delivery address. A dashboard icon 710 displays an interactive dashboard for the user where the details are shown in a pictorial manner.

The interface 700 also displays a client handle 712, current clock time 714, and a notification icon 716 for providing notifications to the client.

At the bottom of the interface, an inventory icon 718 displays the status of the inventory of the client. A purchases icon 720 provides purchased items of the inventory of the client.

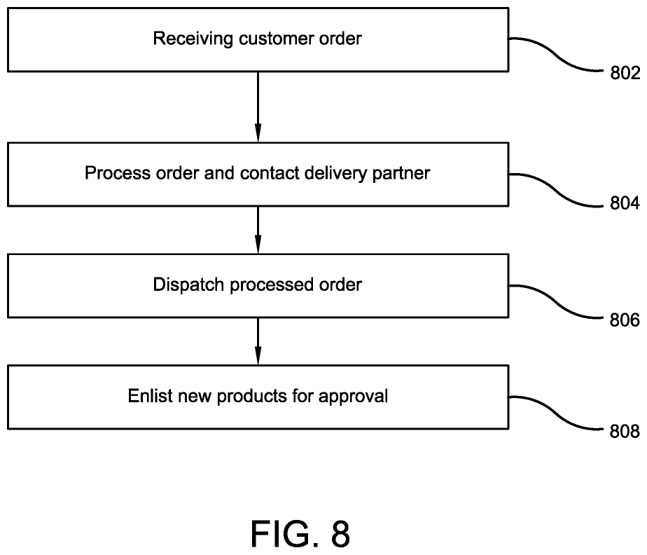

FIG. 8 illustrates a flow diagram depicting a process of processing customer orders by a client on the system 100 in accordance with the disclosed architecture. Initially, a client receives at least one customer order in response to the customer playing the game and making an in-game purchase (Step 802). Upon receiving the order, the client processes the order, packs the order, contacts a delivery partner (Step 804) and dispatches using the delivery partner (Step 806). It should be noted that the client is located in the state of the customer receiving the order. For maintaining inventory, the client lists new approved products for approval and list for the customers (Step 808).

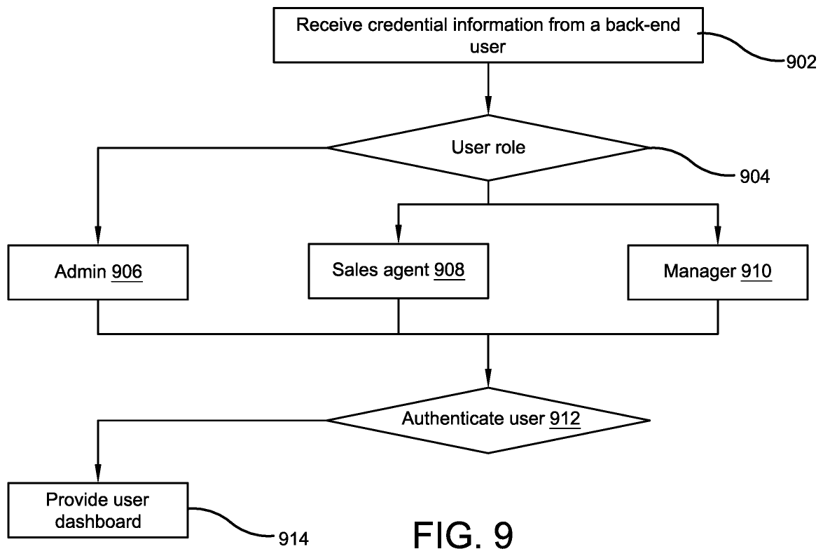

FIG. 9 illustrates a flow diagram depicting a process of authenticating a back-end user of the system of the present invention in accordance with the disclosed architecture. The system has a plurality of back-end users that are separate from the customers and clients described above. The back-end users perform a combination of user roles, tasks, and responsibilities that are assigned to back-end users based on their roles. For example, sales agents and managers are responsible for onboarding providers within the state and get new products enlisted in the game. Administrators manage and monitor surveys, sales, and customer feedback.

When a back-end user logs in the game, credentials are received from the user (Step 902). Then, a user role is received by the user or alternatively can be determined by the system (Step 904). Based on the user type, an admin 906, a sales agent 908, and a manager 910 can be ascertained. Then, authentication of the user takes place in step 912. In case the authentication is successful, then, the user is enabled the customized dashboard (Step 914). It should be appreciated that the order of the steps can be interchanged as per flow of the game system.

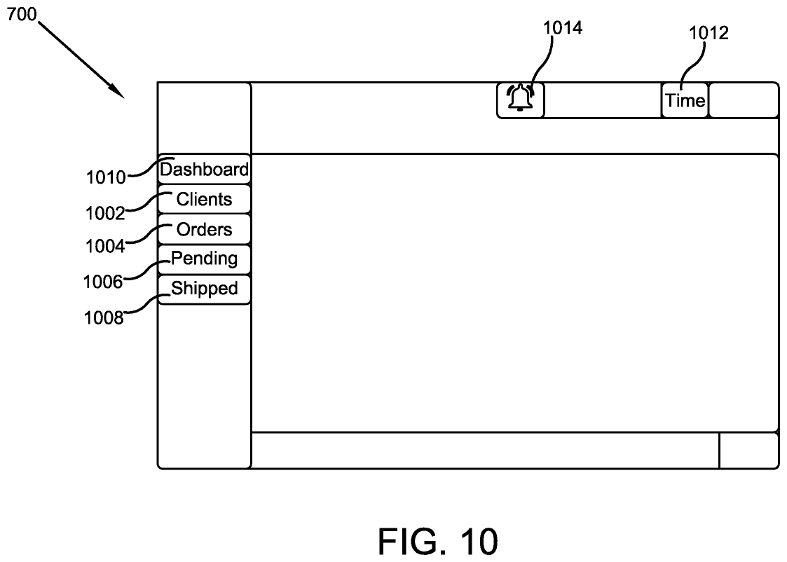

FIG. 10 illustrates an exemplary back-end user interface displayed to a back-end user in accordance with the disclosed architecture. The back-end user dashboard 1000 can be accessed using an electronic device by a client via software application or a website enabled by the system. The back-end user interface has a customer icon 1002, a client icon 1004, a pending icon 1006, a reporting icon 1008. The customer icon 1002, when clicked, displays the list of all the customers of the game along with their personal information and purchase history. The client icon 1004, when clicked, displays the list of clients/sellers enrolled with the game along with their location and other details. The pending icon 1006, when clicked, displays the pending orders and pending client/seller verification and can be used for following up with customers and/or clients. The reporting icon 1008 is used for generating a plurality of reports that can be used by admins and managers for insights of the game system. A dashboard icon 1010 displays a customized dashboard of the user. The dashboard may display a preview of all the information contained for back-end users. The interface 1000 also displays current time 1012 and notification bar 1014 for the back-end user.

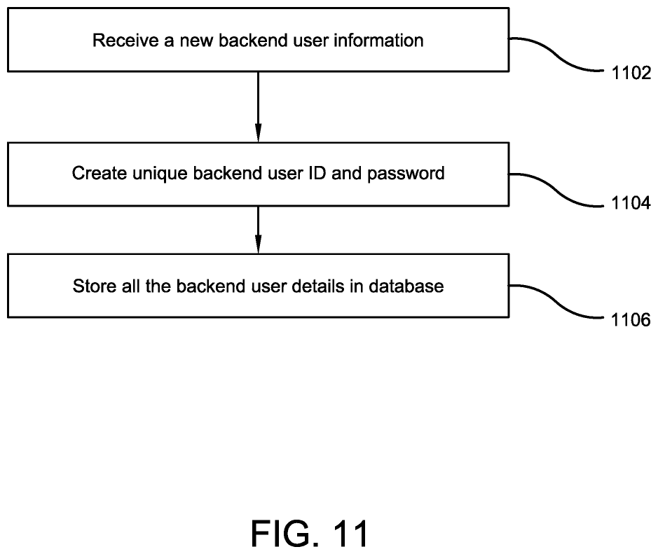

FIG. 11 illustrates a flow diagram showing the process of enrolling back-end user and storing information in accordance with the disclosed architecture. As illustrated, initially, information of a new back-end user is received by the game system (Step 1102). Once the information is authenticated; a unique user ID and password are created for the back-end user to access the game system (Step 1104). Finally, the back-end user details are stored in the database of the server system (Step 1106).

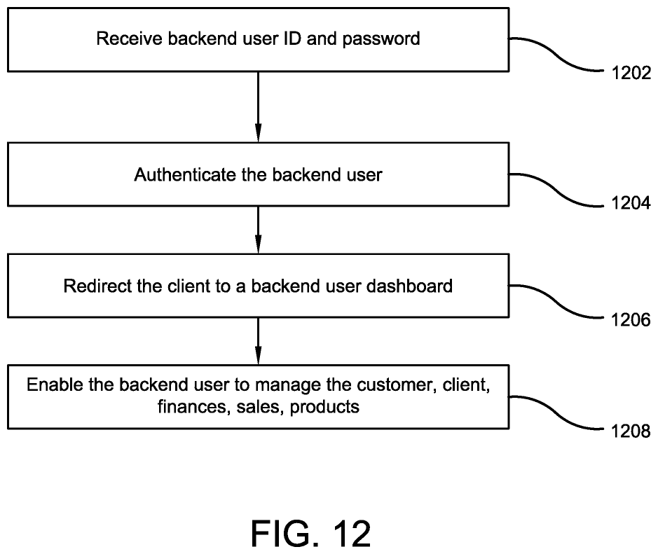

FIG. 12 illustrates a flow diagram showing steps of providing access of game system to a back-end user in accordance with the disclosed architecture. At step 1202, the back-end user opens the cannabis application or cannabis web portal and clicks an existing user button to login into the cannabis management system 100. The back-end user enters the unique back-end user ID and the password to login into the cannabis management system 100. At step 1204, the cannabis management system 100 authenticates the back-end user using a single sign-on method. At step 1206, the back-end user is redirected to the back-end user dashboard when the cannabis management system 100 authenticates the back-end user. At step 1208, the back-end user can manage the customer, client, finances, sales, products, and more using the dashboard.

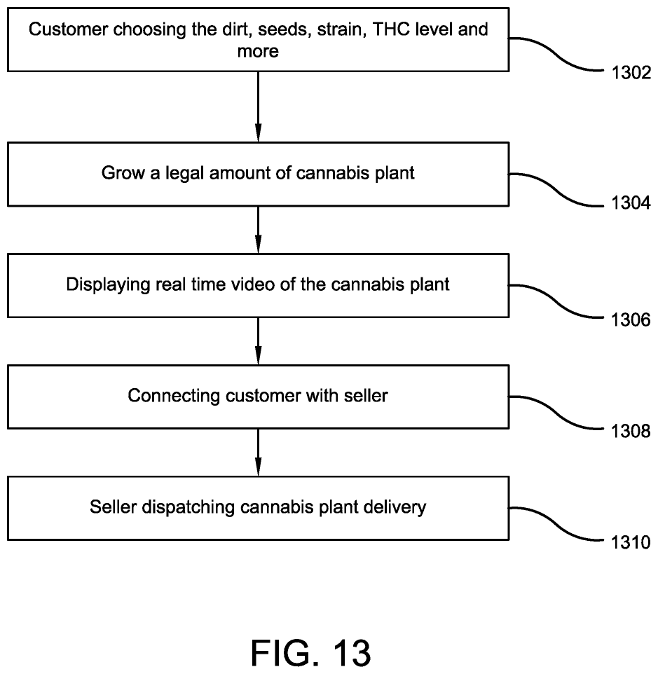

FIG. 13 illustrates a flow diagram showing various tasks performed by a customer for customizing the cannabis products while playing the game in accordance with the disclosed architecture. As illustrated, a customer chooses the farming options of the dirt, seeds, strain, THC level, and more within the game for customizing and growing cannabis related product (Step 1302). Thereafter, while playing the game, customers grow a legal amount of cannabis per delivery cycle in real time (Step 1304). Then, a real time, recorded, or time-lapsed video of the cannabis plant growing is displayed to the user where the plant is, or has been, grown by a laboratory or seller (Step 1306). The video can include growth tips, safety tips, and use tips for the particular product being grown. Additionally, the video can also suggest other products available from the dispensary that are related to the particular product being grown. The customer connects with the seller for ordering the cannabis plant (Step 1308). Finally, the seller dispatches physical plant delivery through a delivery partner (Step 1310).

As used herein, the term “server” or “server system” refers to any computerized component, system, or entity regardless of form which is adapted to provide data, files, applications, content, or other services to one or more other devices or entities on a computer network.

As used herein, the term “user interface” or “dashboard” refers to, without limitation, any visual, graphical, tactile, audible, sensory, or other means of providing information to and/or receiving information from a user or other entity.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “system”, “cannabis game system”, and “game system” are interchangeable and refer to the cannabis ordering game system 100 of the present invention.

Notwithstanding the forgoing, the cannabis ordering game system 100 of the present invention can be of any suitable size and configuration as is known in the art without affecting the overall concept of the invention that it accomplishes the above-stated objectives. One of ordinary skill in the art will appreciate that the cannabis ordering game system 100 as shown in the FIGS. are for illustrative purposes only, and that many other sizes and shapes of the cannabis ordering game system 100 are well within the scope of the present disclosure. Although the dimensions of the cannabis ordering game system 100 are important design parameters for user convenience, the cannabis ordering game system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cannabis management system to create and order cannabis products, the cannabis management system comprising:
a client onboarded on said system, wherein said system includes a computer implemented software application;
a customer registered on said system with a customer device, wherein said customer device is a computing device for accessing said computer implemented software application;
a back-end user for managing said system and said onboarding of said client and registering said customer;
a communication network for communicating between said client and said customer;
wherein said client provides cannabis product farming options to said customers and receives orders from said customers; and
further wherein said computer implemented software application includes a cannabis growing function for performing purchases to select said cannabis product farming options and to order a cannabis product.

2. The cannabis management system of claim 1, wherein said cannabis product farming options are selected from a group consisting of a seed, a strain, and a THC level.

3. The cannabis management system of claim 2, wherein said cannabis growing function includes a real-time video of a growth of said cannabis product.

4. The cannabis management system of claim 2, wherein said cannabis growing function includes a time-lapse video of a growth of said cannabis product.

5. The cannabis management system of claim 2, wherein said client is compliant with state regulations and licensed to sell regulated said cannabis products.

6. The cannabis management system of claim 5, wherein said computer implemented software application includes a registration module configured to enable said customers, said clients, and said back-end users to register on said cannabis management system.

7. The cannabis management system of claim 6 further comprising a customer registration on said cannabis management system, and further wherein said customer registration information selected from a group consisting of a name, an email ID, a password, a date of birth (DOB), and an address.

8. The cannabis management system of claim 7 further comprising a client registration on said cannabis management system, wherein said client registration information selected from a group consisting of by entering a shop name, an email ID, an address, a contract, and an inventory.

9. The cannabis management system of claim 8, wherein said client registration on said cannabis management system further includes a unique client ID and a client password.

10. The cannabis management system of claim 8 further comprising a back-end user registration on said cannabis management system, wherein said back-end user registration includes an enrollment number.

11. The cannabis management system of claim 8 further comprising a storage module configured to enable storage of said customer registration, said client registration, and said back-end user registration.

12. The cannabis management system of claim 11 further comprising an authentication module configured to authenticate received said customer registration, said client registration, and said back-end user registration with said stored said customer registration, said client registration, and said back-end user registration.

13. A cannabis management system to create and order cannabis products, the cannabis management system comprising:
a client onboarded on said system, wherein said system includes a computer implemented software application;
wherein said client is compliant with state regulations and licensed to sell regulated cannabis products;
a customer registered on said system with a customer device, wherein said customer device is a computing device for accessing said computer implemented software application;
a back-end user for managing said system and said onboarding of said client and registering said customer;
a communication network for communicating between said client and said customer;
wherein said client provides cannabis product farming options to said customers and receives orders from said customers;
wherein said computer implemented software application includes a cannabis growing function for performing purchases to select said cannabis product farming options and to order said regulated cannabis products; and
wherein said cannabis product farming options are selected from a group consisting of a seed, a strain, and a THC level.

14. The cannabis management system of claim 13, wherein said cannabis growing function includes a real-time video of a growth of said cannabis product.

15. The cannabis management system of claim 13, wherein said cannabis growing function includes a time-lapse recorded video of a growth of said cannabis product.

16. The cannabis management system of claim 13, wherein said computer implemented software application includes a registration module configured to enable said customers, said clients, and said back-end users to register on said cannabis management system.

17. The cannabis management system of claim 13, further comprising a customer registration on said cannabis management system, wherein said customer registration information selected from a group consisting of a name, an email ID, a password, a date of birth (DOB), and an address.

18. The cannabis management system of claim 17 further comprising a client registration on said cannabis management system, wherein said client registration information selected from a group consisting of by entering a shop name, an email ID, an address, a contract, and an inventory.

19. A method for ordering cannabis products, the method comprising the steps of:
providing a cannabis management system having a computer implemented software application to create and order said cannabis products, wherein said cannabis management system includes a client onboarded on said system compliant with state regulations and licensed to sell regulated cannabis products;
registering a customer registered on said system with a customer device, wherein said customer device is a computing device for accessing said computer implemented software application;
connecting a communication network for communicating between said client and said customer;
ordering cannabis product farming options by said customer;
receiving said cannabis product farming options by said client; and
wherein said cannabis product farming options are selected from a group consisting of a seed, a strain, and a THC level.

20. The method of claim 19, wherein said cannabis product farming options includes a real-time video of a growth of said cannabis products.
